(19) United States
(12) Patent Application Publication
(10) Pub. No.: US 2018/0198247 A1
(43) Pub. Date: Jul. 12, 2018

(54) Modular Assembly Housing

(71) Applicant: AKCess Pro Limited, Bangkok (TH)

(72) Inventors: Bradley KLEIN, Bangkok (TH); Charles MEYER, Bangkok (TH); Scott FARNUM, Bangkok (TH); Nicholas BARROWCLOUGH, Pampanga (PH)

(21) Appl. No.: 15/321,190

(22) PCT Filed: Aug. 10, 2016
(86) PCT No.: PCT/US16/46225

§ 371 Date: Dec. 22, 2016

(51) Int. Cl. H01R 25/14; H02B 1/36

(52) U.S. Cl. CPC H01R 25/145; H02B 1/36; H01R 25/142

(57) ABSTRACT

An apparatus having an enclosure that is mountable on a computer rack. The apparatus comprising: a U-shaped plate, two end-caps, and a module having three faces. The U-shaped plate comprising a channel and forming a bottom face and at least a portion of the front and back faces of the enclosure. The module, which has three faces, is configured to mate with the U-shaped plate via the channel. When the module is mated with the U-shaped plate, the three faces of the module form, at least partially, the top, front and back faces of the enclosure. The two end-caps are configured to be attached to the U-shaped plate at distal ends of the U-shaped plate, wherein, when the two end-caps are attached to the U-shaped plate, side walls of the end-caps form two side faces of the enclosure.

### TECHNICAL FIELD

The present disclosure relates to assembly housing in general, and to modular assembly housing, which may be useful in computer cabinets, in particular.

### BACKGROUND

Data centers have grown in both power usage and complexity requiring the use of integrated systems to control power utilization effectiveness. In large and complex data centers, environmental monitoring sensor technology has merged with power distribution technology enabling data center managers to more accurately control their costs.

The environment monitoring and power distribution unit located in the computer cabinet is the controlling element. As the needs of data center administrators have grown, so has the complexity of the environment monitoring and power distribution units.

This growing complexity of the environment monitoring and power distribution units has given rise to thousands of possible combinations of sensor and power components for a given computer cabinet. Customers have been faced with either expensive custom designed environment monitoring and power distribution unit or settling for standard designs which may not fit their needs. Thus, each type of environment monitoring and power distribution unit in the prior art is typically manufactured with a substantial number of components that are custom designed and manufactured for that environment monitoring and power distribution unit.

In turn the need to custom design individual environment monitoring and power distribution unit systems has increased the manufacturing costs and resulted in shipping delays. Alternatively the approach of pre-manufacturing large numbers of different varieties of environment monitoring and power distribution unit systems has resulted in greater costs due to large inventories, deadstock, out of date environment monitoring and power distribution unit systems. This higher cost in manufacturing has resulted in higher environment monitoring and power distribution unit prices and limited selection. Moreover, pre-manufacturing large numbers of different varieties of apparatuses is conducive to larger warehousing costs needed to store prefabricated inventory, metal wastage due to custom box length and short run manufacturing processes that are inefficient and cause a negative effect on the environment.

U.S. Pat. No. 5,788,521, entitled “Modular surge protection system with interchangeable surge protection modules”, shows a surge protected power strip which has interchangeable modules coupled into each other by means of male and female portions.

U.S. Pat. No. 6,454,584, entitled “Modular surge protection system with interchangeable surge protection modules”, shows a surge protected power strip which has interchangeable modules coupled into each other by means of male and female portions.

U.S. Pat. No. 5,844,763, entitled “Electrical outlet assembly having field replaceable transient voltage surge suppression module”, shows an assembly system for an externally replaceable Transient Voltage Surge Suppression (TVSS) module of a power strip. The apparatus lacks of a full modular enclosure, it is just the TVSS module that can be replaced.

U.S. Pat. No. 5,582,522, entitled “Modular electrical power outlet system”, shows a power strip which has interchangeable power outlet modules coupled to each other by means of electrical legs. The apparatus lacks of a controller module with sensor interface and network communication interface.

U.S. Pat. No. 6,456,203, entitled “Power distribution panel with modular elements”, shows a modular Power Distribution Unit (PDU) with element modules removably mounted to one side of the housing. The modules have a fixed size and are screwed on top and bottom, in a manner requiring substantial installation time.

U.S. Pat. No. 8,207,627, entitled “Adaptive power strip”, shows a power strip which has multiple modules, power and data coupled by the means of terminals to a receptacle with AC, DC power and data bus rails. The AC and DC power rails and communication bus rails are built into the back channel increasing manufacturing costs. The disclosed modules are standalone, having a complete enclosure.

U.S. Pat. No. 7,457,106, entitled “Power distribution unit and methods of making and use including modular construction and assemblies”, shows a power distribution unit which has multiple modules coupled to each other and to the housing.

U.S. Pat. No. 7,535,696, for a “Adaptable rack mountable power distribution apparatus” shows several embodiment of mountable power distribution apparatus using specific shape of the enclosure and brackets to mount in a computer rack. The apparatus lacks of a modular enclosure and of a U-shaped bottom plate where the modules are securely coupled through a male and female channel assembly.

### BRIEF SUMMARY

One exemplary embodiment of the disclosed subject matter is an apparatus having an enclosure, wherein the enclosure is mountable on a computer rack, the apparatus comprising: a U-shaped plate forming a bottom face of the enclosure and at least a portion of a front face of the enclosure and at least a portion of a back face of the enclosure, wherein the U-shaped plate comprising a channel; an electrical module comprising three faces, wherein the electrical module is configured to mate with the U-shaped plate via the channel, wherein, when the electrical module is mated with the U-shaped plate, the three faces of the electrical module form, at least partially, a top, the front and the back faces of the enclosure; and two end-caps configured to be attached to the U-shaped plate at distal ends of the U-shaped plate, wherein, when the two end-caps are attached to the U-shaped plate, side walls of the two end-caps form two side faces of the enclosure.

Optionally, the electrical module comprising a mating channel configured to mate with the channel of the U-shaped plate, wherein the channel and mating channel are configured to allow the electrical module to slide in between the distal ends of the U-shaped plate.

Optionally, the channel and the mating channel are a continuous protrusion and a continuous aperture that match in shape to one another.

Optionally, the channel is the continuous aperture beginning in one distal end of the U-shaped plate and ending in a second distal end thereof.

Optionally, the channel comprises a first continuous aperture on a side wall of the U-shaped plate and a second continuous aperture on an opposing side wall of the U-shaped plate, wherein the first and second continuous apertures begin in one distal end of the U-shaped plate and end in a second distal end thereof.

Optionally, the two end-caps are attached at the distal ends of the U-shaped plate, wherein the two end-caps are configured to be removably attached to the U-shaped plate using a securing means different than the channel, whereby limiting ability to detach the electrical module from the U-shaped plate.

Optionally, the apparatus comprising a plurality of modules, the plurality of modules comprise the electrical module; wherein the channel provides for an attaching mechanism which does not require any tool for mounting or dismounting a module from the U-shaped plate; and wherein the attaching mechanism is configured to prevent a first module from being removed before removing a second module preceding the first module.

Optionally, the plurality of modules comprises a blanking module having no functionality, wherein the blanking module providing a supplemental portion of the front, back and top faces of the enclosure.

Optionally, the plurality of modules comprises two blanking modules having different sizes.

Optionally, an end-cap selected from the two end-caps comprises power input that penetrates an enclosure of the end-cap; wherein the end-cap comprises a power supply circuit feeding power to the electrical module via a cable, wherein the cable passing internally within the enclosure in between the end-cap and the electrical module, wherein each module of the plurality of modules comprising side openings sufficient in size and shape to allow for a cable to pass internally within the enclosure and in-between the modules.

Optionally, the one or more electrical modules are electrically coupled by a single multi-wire cable, wherein the single multi-wire cable comprising DC power lines and communication signals.

Optionally, two mounting brackets are attached to the enclosure at the distal ends, wherein the two mounting brackets are 1U mounting brackets that are configured to allow for mounting the apparatus horizontally within the computer rack while occupying one rack unit (1U) space of the computer rack, wherein the U-shaped plate has a length corresponding an internal width of slots within the computer rack.

Optionally, two mounting brackets are attached to the enclosure at the distal ends, wherein the two mounting brackets 0U mounting brackets that are configured to allow for mounting the apparatus vertically to a computer rack without occupying a rack unit space of the computer rack.

Optionally, a din rail mounting element is attached to the U-shaped back panel.

Optionally, an end-cap selected from the two end-caps comprises two assemblies removably attached, the two assemblies comprising: (i) a removable assembly comprising an outer panel, a power inlet and a power supply circuit; and (ii) a housing assembly securely mating with the U-shaped plate; wherein the removable portion being removably attached to the housing portion; and wherein the electrical module is a controller module, wherein the controller module is further comprised of two assemblies removably attached together comprising: a removable assembly comprising a front panel and controller electronics; and a second assembly housing securely mating with the U-shaped plate, wherein the removable assembly being removably attached to the housing assembly.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a fully assembled modular environment monitoring apparatus 1U mounted, in accordance with some exemplary embodiments of the disclosed subject matter;

FIG. 2 shows a fully assembled environment monitoring and power distribution modular apparatus as a 0U mounted apparatus, in accordance with some exemplary embodiments of the disclosed subject matter:

FIG. 3 shows a U-shaped bottom plate, in accordance with some exemplary embodiments of the disclosed subject matter;

FIGS. 4A-4C show a profiles of a U-shaped bottom plate and modules assembled, in accordance with some exemplary embodiments of the disclosed subject matter;

FIG. 5 shows an end-cap mounted on the U-shaped bottom plate on the U-shaped bottom plate with a 0U Toolless mounting bracket, in accordance with some exemplary embodiments of the disclosed subject matter:

FIG. 6 shows an end-cap with DC power input, in accordance with some exemplary embodiments of the disclosed subject matter;

FIG. 7 shows a removeable end-cap with AC power input, in accordance with some exemplary embodiments of the disclosed subject matter;

FIG. 8 shows a removable main controller module, in accordance with some exemplary embodiments of the disclosed subject matter;

FIG. 9 shows housing modules and an end-cap coupled with rubber gasket, in accordance with some exemplary embodiments of the disclosed subject matter;

FIG. 10 shows a U-shaped bottom plate sliding onto the modules, in accordance with some exemplary embodiments of the disclosed subject matter:

FIG. 11 shows modules connected via a bus cable, in accordance with some exemplary embodiments of the disclosed subject matter;

FIG. 12 shows a fully assembled modular environment monitoring apparatus 1U mounted with blanking module and gaskets between modules, in accordance with some exemplary embodiments of the disclosed subject matter:

FIG. 13 shows a fully assembled environment monitoring and power distribution modular apparatus as a 0U mounted apparatus with a blanking module and gaskets between modules, in accordance with some exemplary embodiments of the disclosed subject matter;

FIG. 14A shows a fully assembled environment monitoring and power distribution modular apparatus as a 0U mounted apparatus with two blanking modules and gaskets between modules, in accordance with some exemplary embodiments of the disclosed subject matter;

FIG. 14B shows an exploded view of an assembled environment monitoring and power distribution modular apparatus as a 0U mounted apparatus with two blanking modules and gaskets between modules, in accordance with some exemplary embodiments of the disclosed subject matter; and

FIG. 15 shows two gaskets with different spacer width, in accordance with some exemplary embodiments of the disclosed subject matter; and

FIG. 16 shows a simple end-cap mounted with 1U mounting bracket and a din rail Toolless mounting element on the U-shape bottom plate, in accordance with some exemplary embodiments of the disclosed subject matter;

FIG. 17 shows a computer cabinet with servers, a 0U mounted an environment monitoring and power distribution modular apparatus and a 1U modular environment monitoring apparatus, in accordance with some exemplary embodiments of the disclosed subject matter; and

FIG. 18 shows an enclosure, in accordance with some exemplary embodiments of the disclosed subject matter.

### DETAILED DESCRIPTION

Described herein are embodiments of a modular enclosure used in computer cabinets. The modular enclosure may be used, inter alia, for environment monitoring systems, for power distribution units, for fire protection systems, combination thereof, or the like. Modules can be easily selected and assembled in order to compose a customizable and configurable unit. In some exemplary embodiments, the apparatus enclosure is composed of two end-caps, one U-shaped bottom plate, and various electrical modules providing desired functionality, all module sliding onto the U-shaped bottom plate in between the two end-caps. Some portions of the modules can be removable for easy maintenance or replacement.

In some exemplary embodiments, the modules themselves may not comprise a complete enclosure, rather a partial enclosure, such as consisting of three faces, may be used. When the modules are attached to the bottom plate, the faces of the bottom plate, together with the faces of the end-caps and the modules, form a rectangular cuboid. In some exemplary embodiments, lack of complete enclosure for each module on its own, may be useful for providing access in between modules, such as to connect a voltage cable, a data bus, or the like. In some exemplary embodiments, a single module may comprise a cable that passes throughout the modular enclosure, passing through several electrical modules and feeding a plurality of modules with power, providing them with a wired communication channel, or the like. Similarly, a single data bus capable may be used to connected two or more electrical modules requiring data feed. In some exemplary embodiments, a plurality of cables may be utilized. Additionally or alternatively, at least one cable may be used to connect a plurality of the electrical modules, such as a sub-portion of all electrical modules requiring power feed may be connected using a single cable. It is understood that an electrical module is any module having an electrical circuit of any sort providing any form of functionality. In some exemplary embodiments, in order to allow for a cable to connect a plurality of modules, each module may have an opening in each side of the module, e.g., absence of a side wall or an aperture in the side wall, such as an aperture providing access for one or more cables thereto, or the like. The side of the module may be a side plane of the module that is orthogonal to an axis of the channel using which the module is connected to the bottom plate.

In some exemplary embodiments, the modules may be connected to the bottom plate using a channel. The modules may be connected to the channel and slide on the channel until reaching their final location. Such a configuration may require attaching the modules in the desired final order, as changing the order of a module may require the removal of modules located before a target module. Such a configuration may have the advantages of relatively low manufacturing costs while maintaining highly flexible design, as well as reduced likelihood of a module being accidently removed or a cable being yanked accidentally due to a module being pulled or removed. Furthermore, such a configuration may not require specific tools for configuration and installation, hence potentially reducing on-site costs as well.

For the purposes of describing some exemplary embodiments of the disclosed subject matter, the elements appearing in the drawings are as follows:
10—an environment monitoring unit
20—an environment monitoring and power distribution unit
100—main controller module
101—U-shaped bottom plate
102—DC power end-cap
103—end-cap
104—blanking module
105—sensor interface module
106—dry contact
107—1U mounting bracket
108—RJ45 sensor interfaces
109—communication interface
110—AC voltage power adapter block
111—front plate
112—screw
113—side screw
114—bottom screw
115—side hole
116—bottom hole
117—top screw
118—top holes
119—2 cm blanking module
120—housing
121—housing
122—housing
123—gasket
124—din rail mounting clip
130—removable main controller portion
131—housing portion
150—computer cabinet
151—1U rack servers
152—1U emplacements
200—AC power end-cap
201—mobile network module
202—circuit breaker module
203—C13 power outlet module
204—locking C19 power outlet module
205—locking C13 power outlet module
206—NEMA power outlet module
207—0U mounting bracket
208—top plate
209—C13 power outlet module
210—power metering module
211—C19 power outlet module
300—female channel
400—module housing
401—male channel
600—a DC to DC circuit board
601—DC power plug
602—opening
700—housing
701—AC to DC power adapter board
702—DC to DC circuit board
703—DC voltage and data bus cable
704—voltage cable
705—AC power inlet
710—circuit board
711—circuit board
801—gasket
802—gasket
1000—top portion of unit
1010—Arrow
1800—front face
1810—back face
1820—top face
1830—bottom face
1840—left side face
1850—right side face

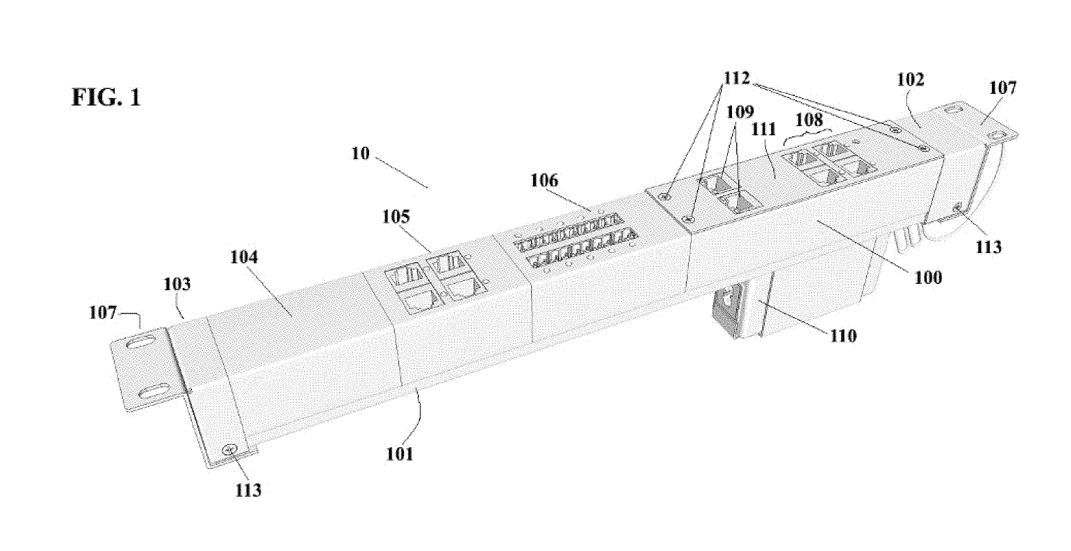

Referring now to FIG. 1, the figure shows a 3D view of embodiment of an environment monitoring unit 10, in a 1U rack mounting form, in accordance with some exemplary embodiments of the disclosed subject matter.

In some exemplary embodiments, unit 10 may have a height of one rack unit (1U, e.g., 1.75″) and length that is compatible with a computer cabinet (e.g., 17″), thereby being horizontally mountable in a computer cabinet and occupying a single slot in the computer cabinet.

The environment monitoring unit 10 is composed of a U-shaped bottom plate 101, a main controller module 100, a dry contact module 106, a sensor interface module 105, a blanking module 104, and two end-caps 102, 103. The main controller module 100 comprises RJ45 sensor interfaces 108 and communication interfaces 109, such as Ethernet and serial communication interfaces. The enclosure of unit 10 is formed out of the faces of the bottom plate 101, the modules 100, 104, 105, 106, and the end-caps 102, 103. In particular, the bottom face of the enclosure is formed out of the bottom plate 101. The top face is formed out of the top faces of the modules 100, 104, 105, 106 and of end-caps 102, 103. The front and back faces are formed by combining the front and back faces of the U-shaped bottom plate 101 with the front and back faces of the components attached thereto: modules 100, 104, 105, 106 and end-caps 102,103. Side faces of the enclosure is formed of the left side face of end-cap 103 and right side face of end-cap 102.

The blanking module may be absent of electric components and may utilized to complete the top, front and back faces of the enclosure. In some exemplary embodiments, the blanking module is used to complete the length of the unit in order to match the dimensions of a computer rack.

In some exemplary embodiments, end-cap 103 is a simple end-cap absent any electrical features. End-cap 103 may consist solely of a housing. End-cap 102 is a DC power end-cap which comprises a DC power inlet and a DC to DC voltage circuit inside the housing of end-cap 102. It will be understood that the disclosed subject matter is not limited to any specific power connection and any sort of power connection could be used as needed for a particular application. In some exemplary embodiments, environment monitoring unit 10 may comprise a single voltage circuit and all electrical modules which require a power feed may be connected, directly or indirectly, to the power feed provided by the voltage circuit in the end-cap 102.

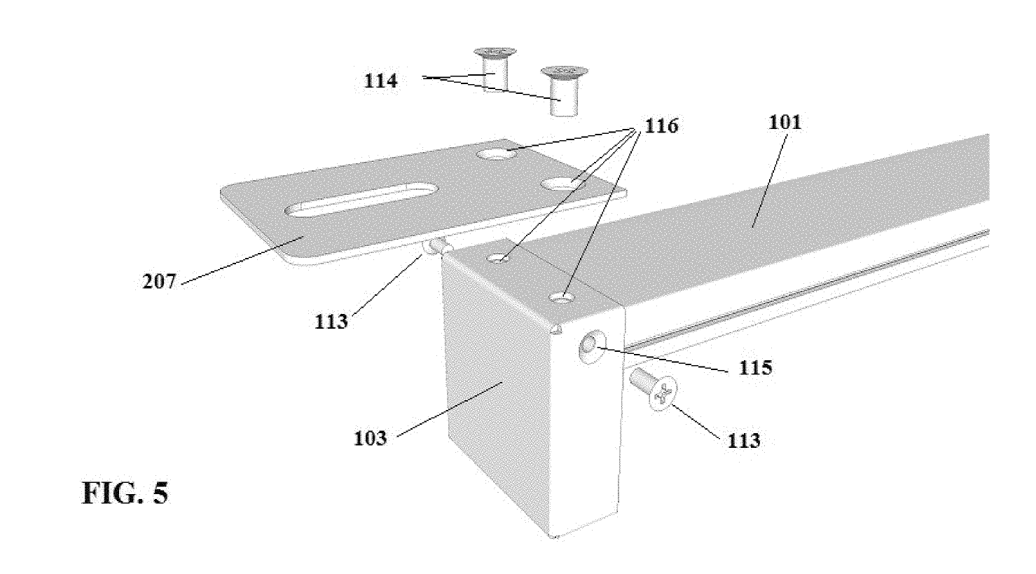

The two end-caps 102 and 103 may be securely attached to the U-shaped bottom plate 101 using screws, such as side screws 113, bottom screws 114 (shown in FIG. 5), or the like. Once end-caps are attached, a fully assembled and closed enclosure for the unit 10 is provided.

Mounting brackets 107 may be attached to the unit 10. The mounting brackets 107 may be adapted in size and shape to attach unit 10 in a 1U rack location within a computer rack, enabling the unit 10 to be mounted horizontally within the computer rack occupying a single rack slot. The mounting brackets 107 may be coupled to the end-caps 102 and 103 using bottom screws 114. 1U mounting bracket 107 may be referred to as a toolless mounting element as it enables a user to mount the unit in a computer cabinet without requiring specific tools, and in fact allows the user to mount the unit using no tools at all beside, potentially, a screwdriver or similar tool.

In some exemplary embodiments, bottom screws 114 may also be useful in securing the end-caps 102, 103 to bottom plate 101 (in addition to or instead of side screws 113).

An AC voltage power adapter block 110 is attached to the U-shaped bottom plate 101. The adapter block 110 may be mounted in 1U configurations in order to provide a designated location for the power block which is used to feed power into unit 10. As the computer rack may not have a holder or shelf where adapter block 110 may be stored. Mounting adapter block 110 may allow users to neatly store the power adapter 110 and just have AC power cable to run from the power strip to the power adapter.

In the embodiment shown in the FIG. 1, the main controller 100 has the ability to be removed without disassembling the whole unit—i.e., without having to disassemble end-cap 102, if opened from the left side, and without having to disassemble end-cap 103 and modules 104, 105, 106, if opened from the right side. Screws 112 secure front plate 111 to main controller 100 and can be removed to provide access to the internals of main controller 100.

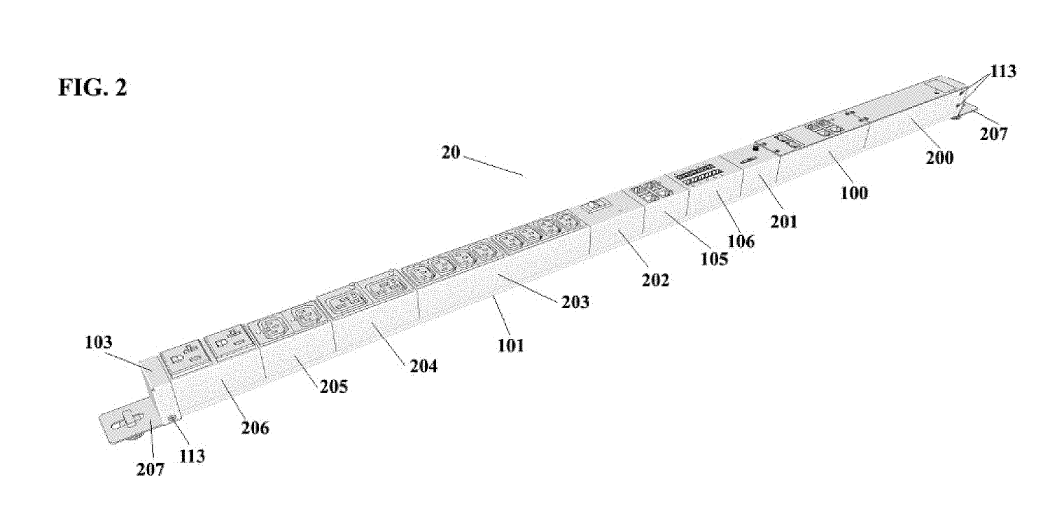

Referring now to FIG. 2, showing an illustration of an environment monitoring and power distribution unit 20 in a 0U rack mounting form, in accordance with some exemplary embodiments of the disclosed subject matter. As is exemplified in FIG. 2, the environment monitoring and power distribution unit 20 is composed of a U-shaped bottom plate 101, a main controller module 100, a mobile network module 201, a ten dry contact module 106, a four sensor interface module 105, a circuit breaker module 202, an eight C13 power outlet module 203, a two locking C19 power outlet module 204, a two locking C13 power outlet module 205 and a two NEMA power outlet module 206. Unit 20 is configured in a 0U rack mounting form, adapted to be mounted in a vertical manner in a computer rack.

In some exemplary embodiments, power outlet modules (203, 204, 205, 206) may provide the power distribution functionality to unit 20. Environment monitoring functionality may be provided by means of sensors connected to modules 105, 106. Additionally or alternatively, mobile network module 201 may provide unit 20 with connectivity to a mobile network, such as using GSM. LTE, or the like.

A circuit breaker module 202 may comprise an automatically operated electrical switch designed to protect the electrical circuit of unit 20 from damage caused by overcurrent, overload or short circuit. In some exemplary embodiments, other protective measures may be used in addition to or instead of the circuit breaker, such as for example a fuse, an Uninterruptible Power Supply (UPS), or the like.

The environment monitoring and power distribution unit 20 is ended by end-caps 103, 200. End-cap 200 is an AC power end-cap which comprises an AC power inlet and an AC to DC voltage circuit inside its housing. The two end-caps 103 and 200 are securely attached to the U-shaped bottom plate 101 by side screws 113 and bottom screws 114 (not visible in FIG. 2) providing a fully assembled and closed unit. Two 0U mounting brackets 207 for attaching the unit in a 0U rack space location are also coupled to the end-caps 103 and 200 by the bottom screws 114.

It will be noted the different modules may be utilized, such as but not limited to the following exemplary modules: a sensor interface module, a dry contact module, a power measurement module, a serial communication interface module, a wireless communication interface module, a mobile network communication module, an Automatic Transfer Switch (ATS) module; a relay controlled module with power outlet sockets, a circuit breaker module, a power supply module, a power relay controlled module; a power outlet module, a transient voltage surge suppression module, a fire protection module, or the like. A sensor interface module may be utilized for plugging a temperature sensor, a smoke detector, a voltage measurement sensor or any input sensor in order to monitor environmental conditions. A dry contact module may be utilized for monitoring inputs such as alarms from third party devices. A power measurement module may be utilized for measuring power consumption and power values from main input feed. A serial communication interface module may be utilized for communicating with third party devices through protocols such as Modbus. CANbus, JBUS or the like. A wireless communication interface module may be utilized for communicating with wireless sensors through protocols such as Zigbee, Xbee or the like. A mobile network communication module may be utilized for sending alert SMS or calls to an end-user. An Automatic Transfer Switch (ATS) module may be utilized for switching the main input power feed to a secondary input power feed in case of failure. A relay controlled module with power outlet sockets may be utilized for powering off or on appliances connected to a power outlet socket. A circuit breaker module may be utilized for powering off a circuit in case of overcurrent, overload or short-circuit. A power supply module may be utilized for converting AC power to DC power and distributing DC power to other modules. A power relay controlled module may be utilized for powering off or on other modules. A power outlet module may be utilized for powering appliances connected to the outlet. A transient voltage surge suppression module may be utilized for suppressing voltage surges and thereby to protect other modules from voltage surges. A fire protection module may be utilized for detecting fire and release an extinguishing gas.

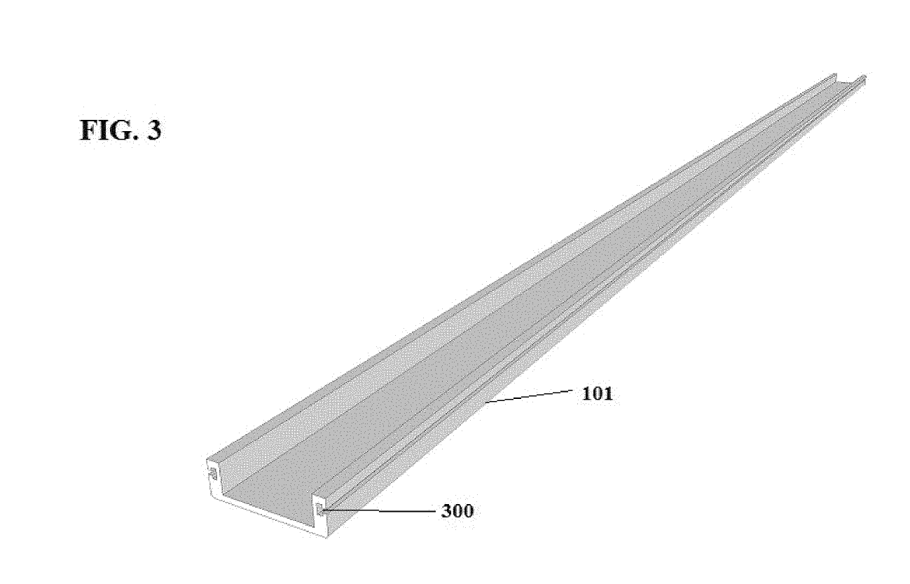

Referring now to FIG. 3 showing an embodiment of the U-shaped bottom plate 101, in accordance with some exemplary embodiments of the disclosed subject matter. Bottom plate 101 comprises a female channel 300 in its side panels. The female channel 300 is used for sliding in a corresponding male channel in modules that are mounted on and attached to the bottom plate 101. In some exemplary embodiments, bottom plate 101 may comprise a male channel, which is configured to mate with a female channel on the modules. Additionally or alternatively, other forms of channels may be used for enabling the modules to be attached to bottom plate 101, and slide into their user-selected location.

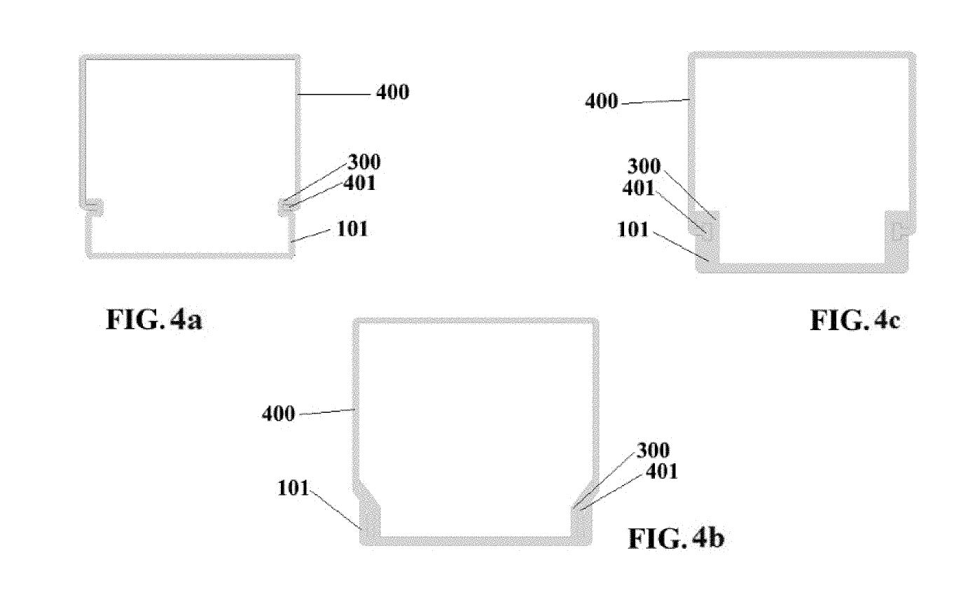

FIGS. 4A, 4B, and 4C show alternative profiles of modules, in accordance with the disclosed subject matter. Module housing 400 comprises a male channel 401. The U-shaped bottom plate 101 comprises a female channel 300), which matches the male channel 401. It will be understood that this is for example purposes, and any sort of shape of male and female channels could be used as needed for a particular application, within the teachings of the disclosed subject matter.

Referring now to FIG. 5 showing a view of an embodiment of a simple end-cap 103 and a 0U bracket 207 along with the side screws 113 and bottom screws 114, in accordance with some embodiments of the disclosed subject matter. Side screws 113 are screwed in side holes 115 having the same dimension on both the end-cap 103 and the U-shaped bottom plate 101. In a similar manner, the bottom screws 114 are screwed in bottom holes 116 having the same dimension and location on the end-cap 103, the U-shaped bottom plate 101 and the 0U bracket 207.

0U bracket 207 may be referred to as a toolless mounting element as it enables a user to mount the unit without requiring specific tools, and in fact allows the user to mount the unit using no tools at all beside, potentially, a screwdriver or similar tool.

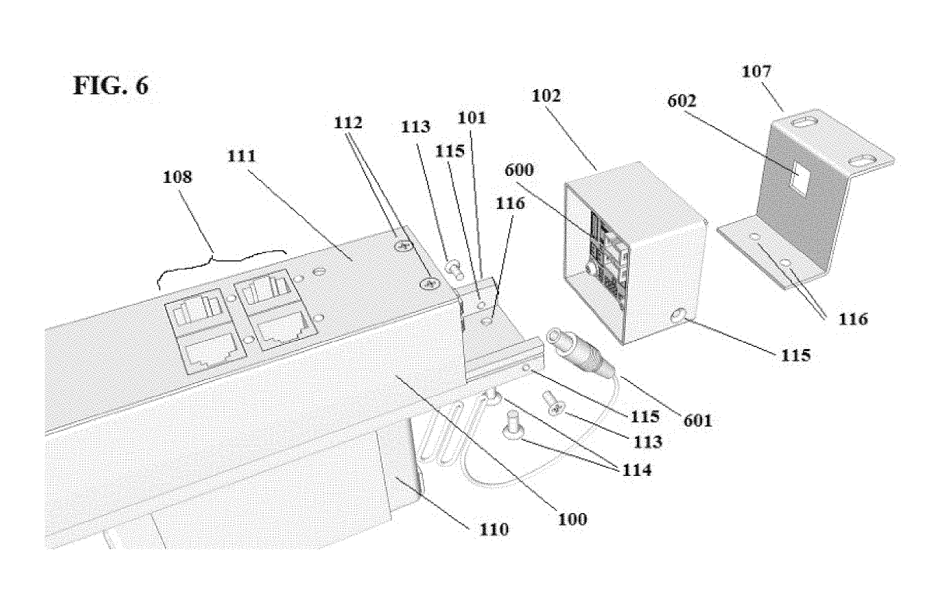

Referring now to FIG. 6 showing an embodiment of a DC power end-cap 102 and 1U mounting bracket 107 along with the side screws 113 and bottom screws 114. The side screws 113 are screwed in side holes 115 having the same dimension on both the end-cap 103 and the U-shaped bottom plate 101. In a similar manner, the bottom screws 114 are screwed in bottom holes 116 having the same dimension and location on the end-cap 102, the U-shaped bottom plate 101 and the 0U bracket 107.

In the embodiment of FIG. 6, the DC power end-cap comprises a DC to DC circuit board 600 with DC connector. DC power plug 601 of the power adapter 110 plugs into the DC connector. In order to provide access for power plug 601 to the DC connector, bracket 107 comprises an opening 602 sufficient in size and shape to allow for power plug 601 to pass through. Additionally, end-cap 102 is absent of any side walls, thereby providing access to a plug that passes through opening 602. The DC to DC circuit board 600 is used for powering the main controller module 100 and other modules not shown in FIG. 6.

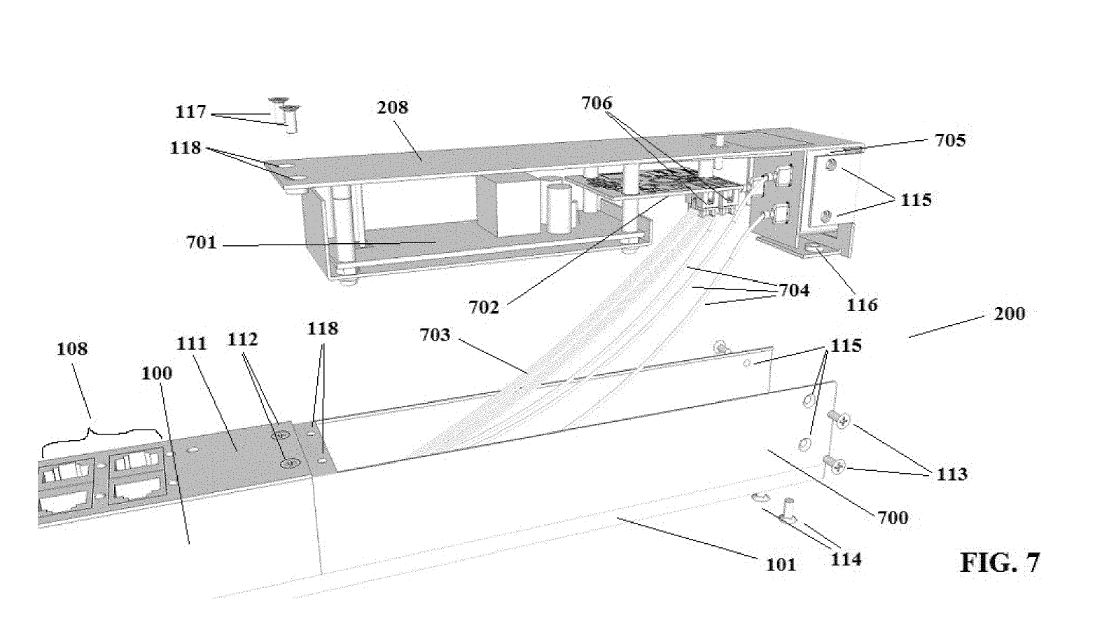

Referring now to FIG. 7, the figure shows a 3D view of an embodiment of a replaceable AC power end-cap 200. The replaceable AC power end-cap 200 comprises of a housing 700 that slides onto the U-shaped bottom plate 101. The replaceable AC power end-cap 200 further comprises a top plate 208. An AC power inlet 705 is connected to the top plate 208. An internal AC to DC power adapter board 701 is connected to the top plate 208. A DC to DC circuit board 702 is connected to the top plate 208. The height of the top plate together with additional boards connected thereto may be smaller than the height of housing 700 to allow cables to be connected to the boards and pass to other modules such as main controller module 100, or modules that are located after main controller module 100 (not shown). In FIG. 7, DC voltage and data bus cables 703, also referred to as an Insulation-Displacement Connector (IDC) ribbon cable, are connected to data bus headers 706 in DC to DC circuit board 702. Similarly, AC voltage cables 704 are connected to AC power inlet 705. In some exemplary embodiments, power to all other modules in unit 200 is provided via a connection, direct or indirect, to the replaceable AC power end-cap 200.

The replaceable AC power end-cap 208 is securely attached to its housing 700 by the mean of side screws 113 and top screws 117. The side and top screws 113 and 117 are screwed in corresponding side and top holes 115 and 118, having the same dimension on both the end-cap 103 and the housing 700. In a similar manner, the bottom screws 114 are screwed in bottom holes 116 having the same dimension and location on the end-cap 208 and the U-shaped bottom plate 101.

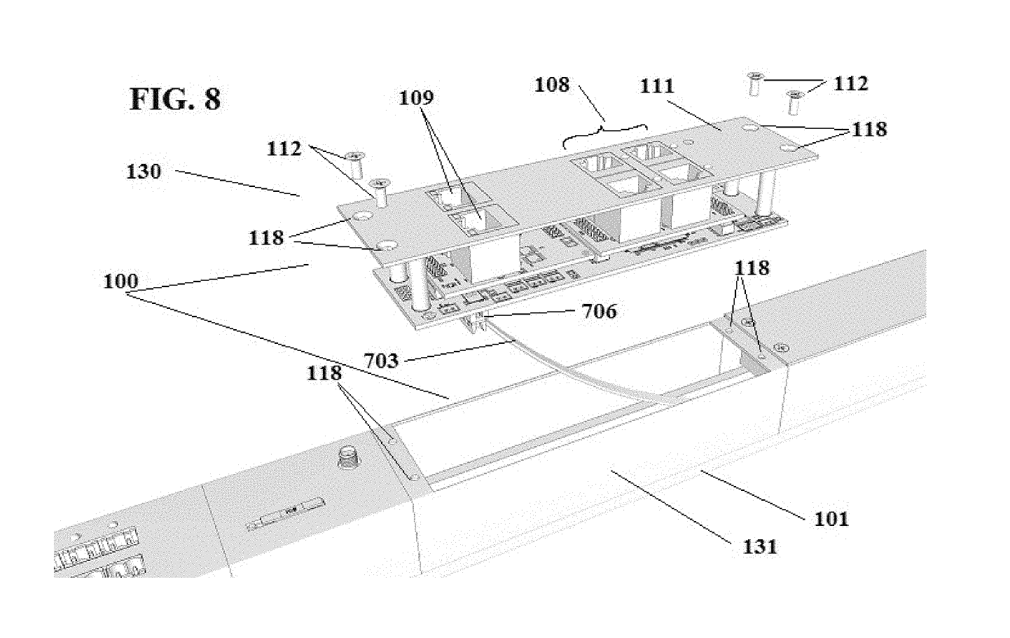

Referring now to FIG. 8, showing an embodiment of a main controller module 100, having a removable main controller portion 130 and a housing portion 131. The housing portion may comprise a male channel (not shown) for securing housing portion 131 to bottom plate 101 and for enabling housing portion 131 to slide back and forth on the corresponding female channel (not shown) of bottom plate 101. In some exemplary embodiments, the main controller module 100 is only electrically coupled to the rest of the modules by the DC voltage and data bus cable 703 via a dedicated header 706. The modules themselves may not be physically connected to one another (besides possible connection via cables), and they may not be secure to one another. The removable main controller portion 130 is removably attached to housing portion 131 by the mean of top screws 112 which are screwed in corresponding top holes 118, having the same dimension on both the front-plate 111 and the housing 131. It will be understood that this is for example purposes, and any sort of connection could be used as needed for a particular application, within the teachings of the disclosed subject matter.

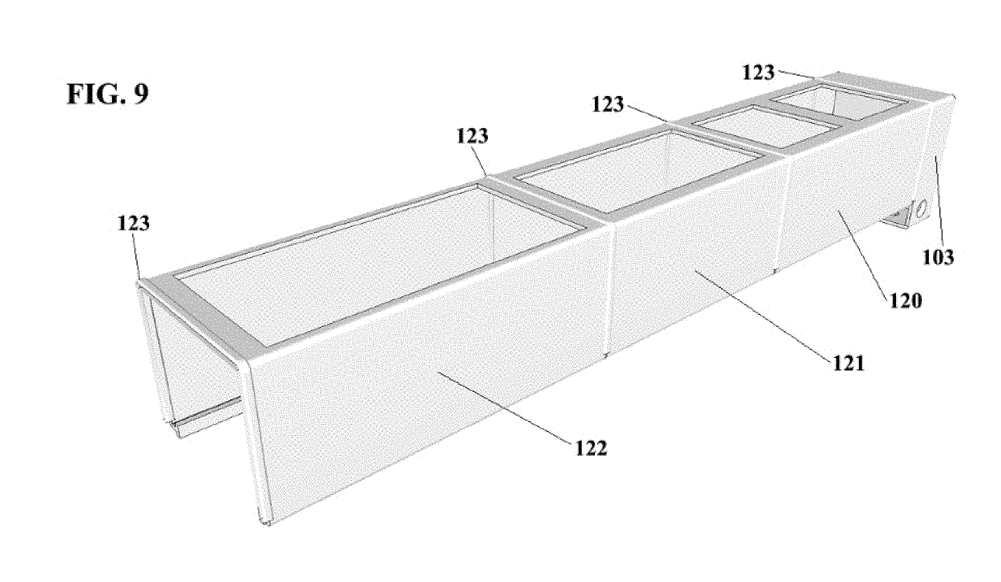

Referring now to FIG. 9, showing an embodiment of several module housings 120, 121 and 122 and a simple end-cap 103, having compressible gaskets 123 between each module edges. Gaskets 123 may be used in order to produce a better overall and tight assembly. Gaskets 123 may also be used to avoid any loose space between modules due to external forces. Gaskets 123 may be compressible allowing a fixed-length blanking module to fit a pre-cut U-shaped bottom plate.

In some exemplary embodiments, during assembly of a unit in accordance with the disclosed subject matter, electrical modules are selected and slide upon the bottom plate to their designated location, with gaskets mounted in between modules. If the length of the bottom plate is larger than the total length of the selected modules and gaskets in-between, one or more blanking modules may be added to complete the unit and provide for a complete enclosure without adding additional functionality to the unit. As the gasket 123 may be compressible and have possible varying width, exact precision may not be required and a blanking module of an approximated correct length may be used by squeezing some or all of the gaskets 123 to minimize their contribution to the total size of the enclosure.

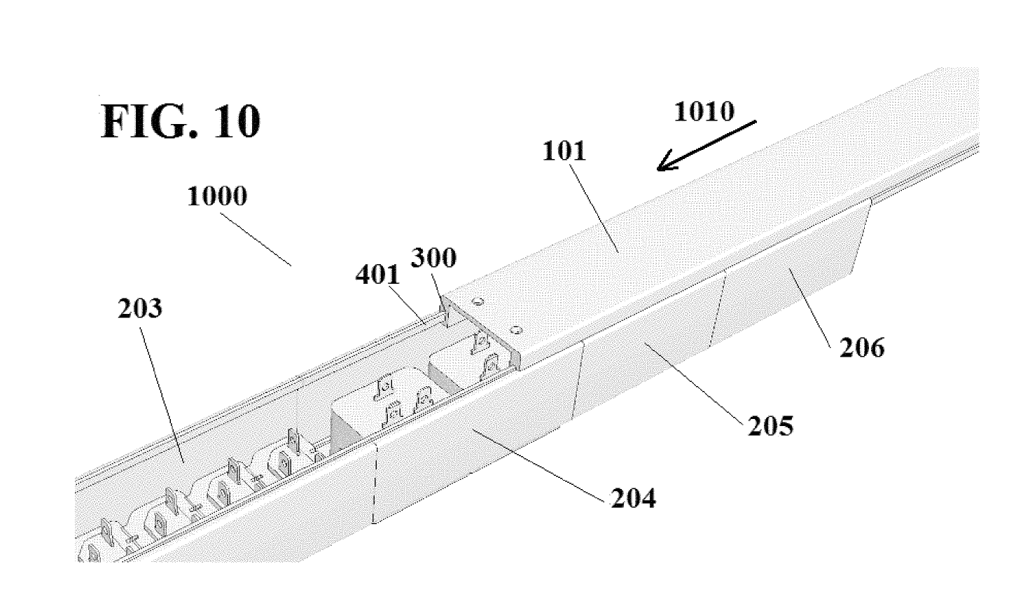

Referring now to FIG. 10, showing a Power Distribution Unit (PDU) in accordance with some exemplary embodiments of the disclosed subject matter. Modules 206, 205, 204 and 203 of PDU are assembled together to form a top portion of the unit 1000. The top portion of the unit is coupled with a U-shaped bottom plate 101. Male channel 401 in the housing of each module is compatible with the female channel 300 of the U-shaped bottom plate 101. Bottom plate 101 may slide in the direction indicated by arrow 1010. In some exemplary embodiments, each module may be connected to bottom plate 101 individually. Additionally or alternatively, the modules may be turned upside-down, as is shown in FIG. 10, and placed on a surface, such as a floor or a table. The modules themselves may not be secured to one another but rather simply placed adjacent to one another. In some exemplary embodiments, the housings of the modules may not be connected or attached to one another. Additionally or alternatively, a user may connect cables from one module to another, such as in order to provide voltage feed, data feed, or the like. Once the user slides bottom plate 101 onto top portion of the unit 1000, using the corresponding channels, the modules are secured to the bottom plate 101 and indirectly to one another. A user cannot remove module 204 without first removing one of the modules surrounding its (e.g., modules 205 or 203). Hence, a user cannot mistakenly pull one module to disconnect it, and potentially tear a cable connected thereto.

In some exemplary embodiments, the mating channel may be configured to allow sliding one channel into the other. In some exemplary embodiments, the module may be configured to be coupled to the U-shaped bottom plate by snapping on to the plate. The modules may comprise of flexible material, such as for their side walls, which can bend or compress enough to snap on to fit the channel of the module with the corresponding mating channel in the bottom plate. Additionally or alternatively, the mating channel itself may be flexible, so as to allow the mating channel to bend or compress sufficiently in size so as to snap on and fit into place with the corresponding mating channel.

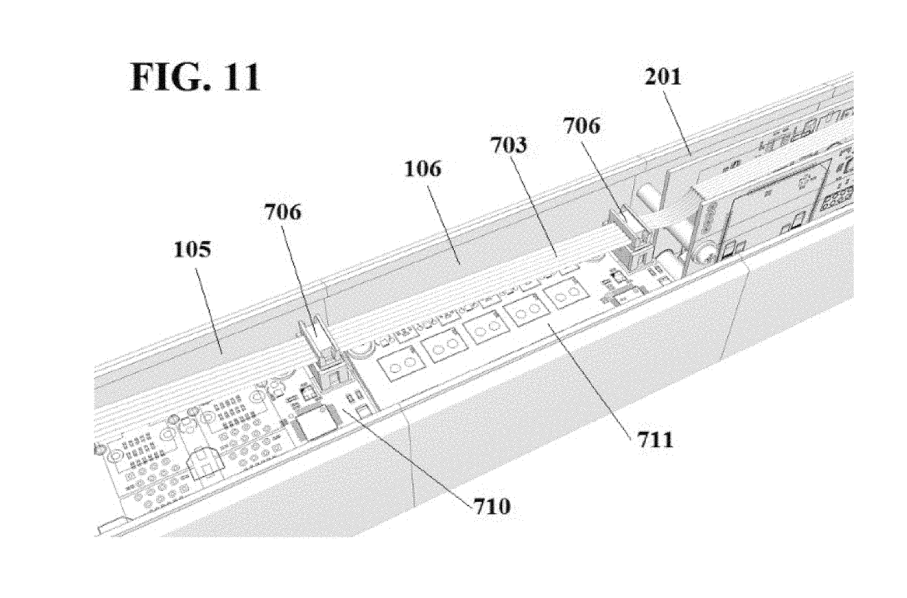

Referring now to FIG. 11, showing a unit in accordance with some exemplary embodiments of the disclosed subject matter. Several modules 106 and 105 of the unit showing in FIG. 11 are aligned and their respective circuit boards 711 and 710 are electrically coupled to each other through the DC voltage and data bus cable 703 via dedicated headers 706. Mobile network module 201 is also electrically coupled to modules 105, 106 via the same DC voltage and data bus cable 703.

It will be understood that this is for example purposes, and any sort of connection and cable could be used as needed for a particular application, within the teachings of the disclosed subject matter.

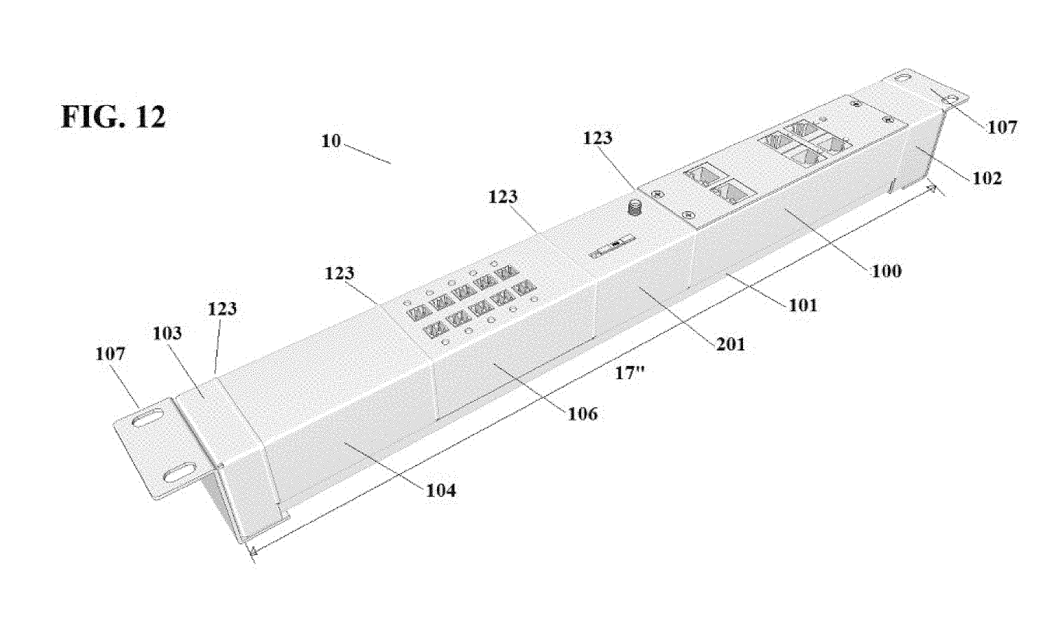

Referring to FIG. 12, showing an environment monitoring unit 10, in accordance with some exemplary embodiments of the disclosed subject matter. Unit 10 so is in a 1U rack mounting form, using an assembly in accordance with the disclosed subject matter. The environment monitoring unit 10 comprises a U-shaped bottom plate 101, of a total length of seventeen inches, a main controller module 100, a mobile network module 201, a ten dry contact module 106, a blanking module 104 and compressible gaskets 123, and two different end-caps 102 and 103. Two brackets 107 for attaching the unit in a 1U rack location are coupled to the end-caps 102 and 103.

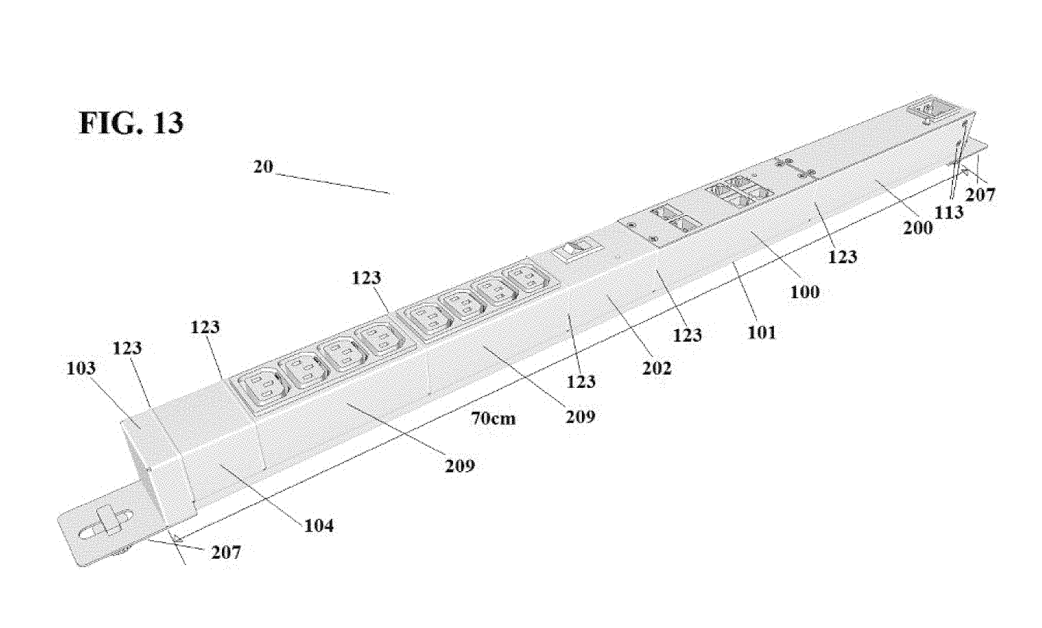

Referring to FIG. 13, showing an environment monitoring and power distribution unit 20 in a 0U rack mounting form, in accordance with some exemplary embodiments of the disclosed subject matter. Unit 20 comprises a U-shaped bottom plate 101, of a total length of seventy centimeters, a main controller module 100, a circuit breaker module 202, two four C13 power outlet module 209, a blanking module 104 and compressible gasket 123, and two different end-caps 103 and 200. Two brackets 207 for attaching the unit in a 0U rack location are coupled to the end-caps 102 and 200.

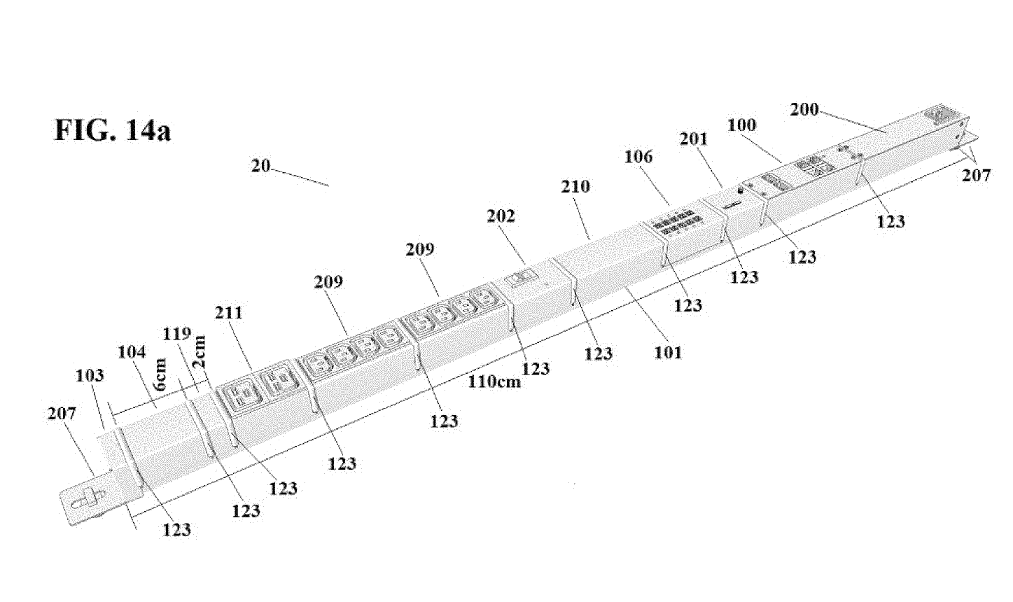

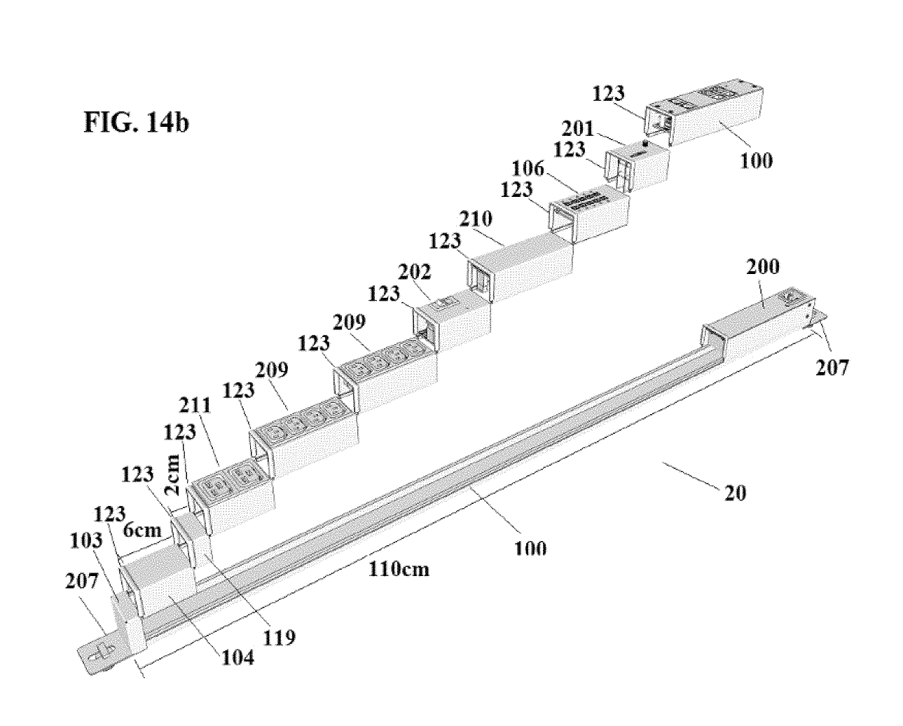

Referring now to FIGS. 14A and 14B, showing a fully assembled and an exploded view of an environment monitoring and power distribution unit 20 in a 0U rack mounting form, in accordance with some exemplary embodiments of the disclosed subject matter. The environment monitoring and power distribution unit 20 is composed of a U-shaped bottom plate 101, having a total length of hundred and ten centimeters, a main controller module 100, a mobile network module 201, a ten dry contact module 106, a power metering module 210, a circuit breaker module 202, two four C13 power outlet module 209, a two C19 power outlet module 211, a two centimeter blanking module 119, a six centimeter blanking module 104, and of compressible gaskets 123, and two different end-caps 103 and 200. Two brackets 207 for attaching the unit in a 0U rack location are also coupled to the end-caps 102 and 200.

As is exemplified in FIG. 14A, a number of blanking modules of different sizes may be used to compete the modules and to account for empty portions of bottom plate 101. Blanking modules together with gaskets may provide for a modular assembly with flexible sizes of different electrical modules, as a user may use them to cover portion of the bottom plate 101 which are not covered by electrical modules or end-caps. Blanking module may be supplied in various sizes, such as 2 cm, 3 cm, 5 cm, or the like, allowing a user who wishes to assemble a unit to not be constrained by having to reach a final desired target size of the bottom plate 101 using the electrical modules.

As can be appreciated from FIGS. 13 and 14A-14B, units having 0U form factor may have different lengths, as such a unit is mounted vertically on the computer cabinet. However, units having 1U form factor have predetermined width of 17″, as is dictated by the internal width of the computer cabinet.

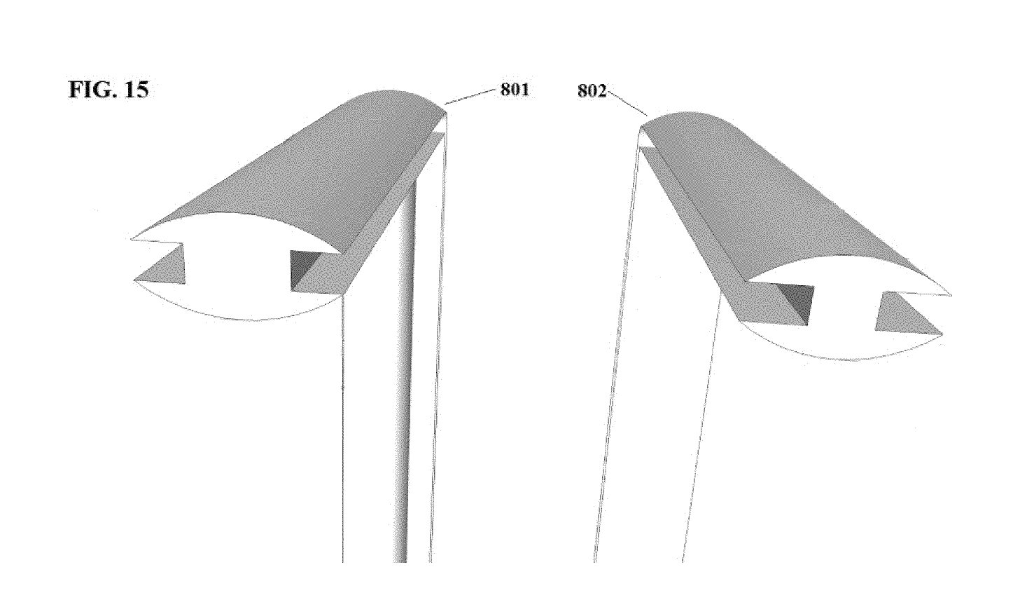

Referring now to FIG. 15, showing two embodiments of compressible gaskets 801 and 802. Gasket 801 has a spacer width of three millimeters. Gasket 802 has a spacer width of two millimeters. It will be understood that this is for example purposes, and any sort of size and form could be used as needed for a particular application, within the teachings of the invention.

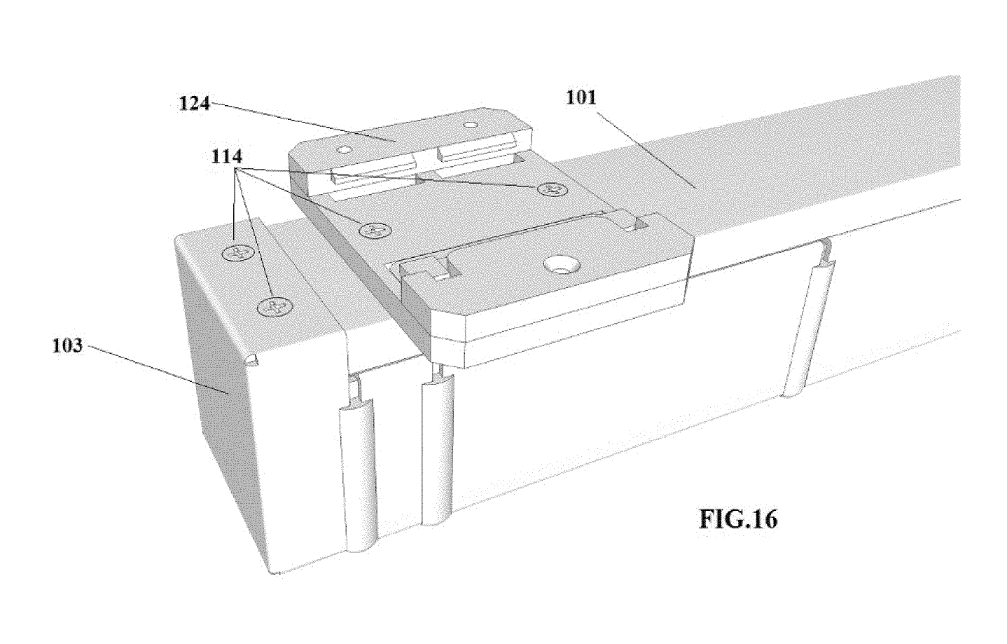

Referring now to FIG. 16, showing an embodiment using a din rail mounting clip, in accordance with some exemplary embodiments of the disclosed subject matter. An end-cap 103 is shown to not be connected to mounting bracket. Instead, a din rail mounting clip 124 is removably attached to bottom plate 101 with bottom screws 114. Additionally or alternatively, the din rail mounting clip 124 may be connected to end-cap 103. Din rail mounting clip 124 may be used to mount the unit on a din rail. The din rail may be comprised by an equipment rack, hang on a wall, or the like. It will be understood that this is for example purposes, and any sort of bracket and din rail mounting element could be used or not as needed for a particular application, within the teachings of the disclosed subject matter.

Din rail mounting clip 124 may be a toolless mounting element as it enables a user to mount the unit without requiring any tools. It will be noted that a screw driver may be required to screw the din rail mounting clip 124 on the back channel. However, after assembled, the din rail mounting clip 124 may be utilized to mount the unit onto a din rail without requiring any tool.

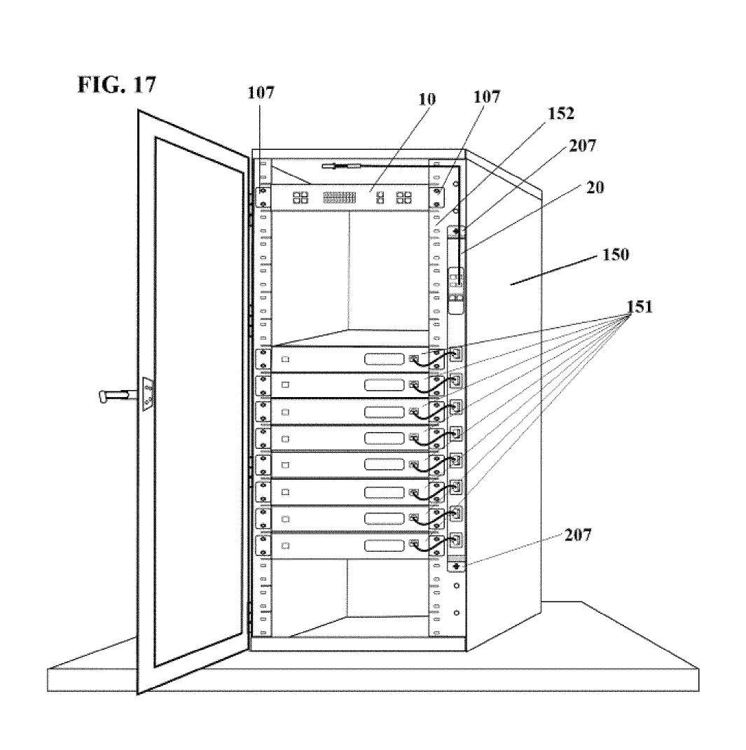

FIG. 17 shows a computer cabinet, in accordance with some exemplary embodiments of the disclosed subject matter.

Computer cabinet 150 comprises a plurality of 1U slots, also referred to as 1U emplacements 152. 1U rack servers 151 are mounted in computer cabinet 150 in corresponding 1U emplacements 152. The 1U rack servers 151 are powered by an environment monitoring and power distribution unit 20 in a 0U rack mounting form. Unit 20 is attached to an internal frame of the computer cabinet 150 by the mean of 0U mounting brackets 207. The computer cabinet 150 also includes an environment monitoring unit 10, in a 1U rack mounting form, which is attached to the internal frame of the computer cabinet 150 using 1U mounting brackets 107. The environment monitoring unit 10 is occupying a 1U rack space of the computer cabinet 150.

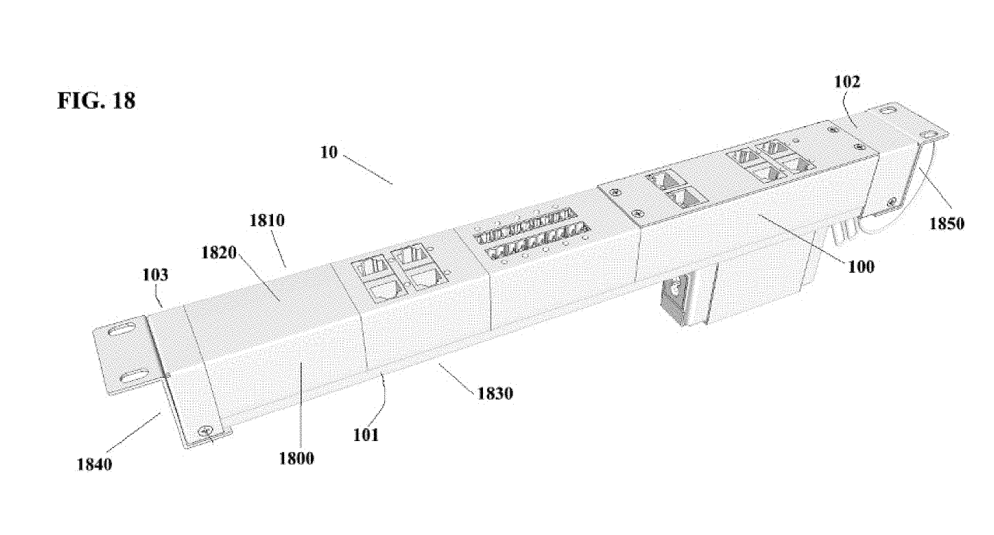

FIG. 18 shows an enclosure, in accordance with some exemplary embodiments of the disclosed subject matter.

The enclosure of unit 10 is a rectangular cuboid having a front face 1800, a back face 1810, a top face 1820, a bottom face 1830, a left side face 1840 and a right side face 1850.

The top face 1820 of the enclosure may be defined as the face comprising switches, plugs or other components with which the user using the unit 10 when mounted in a computer rack. The face opposing the top face 1820 is the bottom face 1830. The faces that are orthogonal to top face 1820 and have a same length as the top face 1820 are the front face 1800 and back face 1810. It will be noted that the drawings refer to front face 1800 as the face which is visible from the displayed view of the unit 10, and the back face 1810 is the opposing face thereof. However, such faces are interchangeable and the terminology used herein is provided solely for the purpose of clarity of the disclosure. The faces of the unit 10 at its distal ends are referred to as left side face 1840 and right side face 1850. It will be noted that the side faces are interchangeable as well and the terminology used herein is provided solely for the purpose of clarity of the disclosure.

The faces of bottom plate 101 form bottom face 1830 and portions of the front face 1800 and back face 1810. Components that are attached to bottom plate 101 form, together, the top face 1820. As an example, the components comprise electrical modules providing functionality of the unit 10, such as main controller module 100. The components may further comprise blanking module 106 used to complete the enclosure without providing additional functionality to the unit. The components may comprise end-caps 102, 103 attached at the distal ends of the enclosure. Front faces of the components, together with the front face of the bottom plate 101 form the front face 1800 of the enclosure. Similarly, back faces of the components, together with the back face of the bottom plate 101 form the back face 1810 of the enclosure.

Left side face of end-cap 103 positioned at the left distal end of unit 10 forms the left side face 1840 of the enclosure of unit 10. Right side face of end-cap 103 position at the right distal end of unit 10 from the right side face 1850 of the enclosure of unit 10.

In some exemplary embodiments, on-site installation of a modular unit in a computer rack in accordance with the disclosed subject matter may comprise some or all of the following steps. The modules may be selected to be used in the modular unit based on their functionality and desired functionality of the unit. The modules may be placed adjacently to one another. In some exemplary embodiments, one or more blanking modules may be added to complete the length of the modules, together with end-caps to a length of a pre-cut U-shaped plate. In some exemplary embodiments, blanking modules may be selected from a variety of blanking modules having different sizes, for example 2 cm, 3 cm, 5 cm, or the like. Additionally or alternatively, gaskets may be added in between modules.

One or more cables, such as multi-wire cable, may be connected between the modules. In some exemplary embodiments, a cable may be used to feed power supply from a power source to electrical modules.

The U-shaped bottom plate may be slide using a channel comprising by the U-shaped plate and corresponding channel in the modules, thereby creating a cuboid enclosure of the modular unit, having top, bottom, front and back faces.

An end-cap may be attached in each distal end of the U-shaped plate. The end-caps may be secured using a securing means different than the channel that may be used instead of or in addition to the channel. By attaching the end-caps side faces of the cuboid enclosure may be added, thereby completing the cuboid enclosure.

A mounting element may be attached to the U-shaped plate and used to mount the modular unit in a computer rack. In some exemplary embodiments, the mounting element may be two 1 U mounting brackets which can be used to mount the modular unit horizontally within the computer rack while occupying one rack unit (1U) space of the computer rack. In such a case, the U-shaped plate may be pre-cut and having a length corresponding to an internal width of slots within the computer rack. Additionally or alternatively, the mounting element may be two 0U mounting brackets that are used for attaching the modular unit vertically to a computer rack without occupying a rack unit space of the computer rack.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

The disclosed subject matter is not limited to specific electrical modules, connector, sensors, or similar components, as described in the above embodiments. In particular, the type of outlets, sensors, connectors and their specific number in a module may be a matter of choice and the disclosed subject matter is not limited to such number, unless specifically stated differently in the claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus having an enclosure, wherein said enclosure is mountable on a computer rack, said apparatus comprising:
a U-shaped plate forming a bottom face of said enclosure and at least a portion of a front face of said enclosure and at least a portion of a back face of said enclosure, wherein said U-shaped plate comprising a channel;
a plurality of modules, wherein the plurality of modules comprise at least an electrical module, wherein each module of the plurality of modules comprising three faces, wherein said each module is configured to mate with said U-shaped plate via said channel, wherein, when said each module is mated with said U-shaped plate, the three faces of said each module form, at least partially, a top, the front and the back faces of the enclosure;
wherein a portion of two or more modules from the plurality of modules are electrically coupled by one or more cables; and
two end-caps configured to be attached to said U-shaped plate at distal ends of said U-shaped plate, wherein, when said two end-caps are attached to said U-shaped plate, side walls of said two end-caps form two side faces of the enclosure.

2. The apparatus of claim 1, wherein said electrical module comprising a mating channel configured to mate with said channel of said U-shaped plate, wherein said channel and mating channel are configured to allow said electrical module to slide in between the distal ends of said U-shaped plate.

3. The apparatus of claim 2, wherein said channel and said mating channel are a continuous protrusion and a continuous aperture that match in shape to one another.

4. The apparatus of claim 3, wherein said channel is the continuous aperture beginning in one distal end of said U-shaped plate and ending in a second distal end thereof.

5. The apparatus of claim 3, wherein said channel comprises a first continuous aperture on a side wall of said U-shaped plate and a second continuous aperture on an opposing side wall of said U-shaped plate, wherein said first and second continuous apertures begin in one distal end of said U-shaped plate and end in a second distal end thereof.

6. The apparatus of claim 2, wherein said two end-caps are attached at the distal ends of said U-shaped plate, wherein said two end-caps are configured to be removably attached to said U-shaped plate using a securing means different than said channel, whereby limiting ability to detach said electrical module from said U-shaped plate.

7. The apparatus of claim 1, wherein said channel provides for an attaching mechanism which does not require any tool for mounting or dismounting a module from the U-shaped plate; and wherein the attaching mechanism is configured to prevent a first module from being removed before removing a second module preceding said first module.

8. The apparatus of claim 1, wherein said plurality of modules comprises a blanking module having no functionality, wherein said blanking module providing a supplemental portion of the front, back and top faces of said enclosure.

9. The apparatus of claim 1, wherein said plurality of modules comprises two blanking modules having different sizes.

10. An apparatus having an enclosure, wherein said enclosure is mountable on a computer rack, said apparatus comprising:
a U-shaped plate forming a bottom face of said enclosure and at least a portion of a front face of said enclosure and at least a portion of a back face of said enclosure, wherein said U-shaped plate comprising a channel;
an electrical module comprising three faces, wherein said electrical module is configured to mate with said U-shaped plate via said channel, wherein, when said electrical module is mated with said U-shaped plate, the three faces of said electrical module form, at least partially, a top, the front and the back faces of the enclosure; and
two end-caps configured to be attached to said U-shaped plate at distal ends of said U-shaped plate, wherein, when said two end-caps are attached to said U-shaped plate, side walls of said two end-caps form two side faces of the enclosure, wherein an end-cap selected from said two end-caps comprises power input that penetrates an enclosure of the end-cap; wherein said end-cap comprises a power supply circuit feeding power to said electrical module via a cable, wherein said cable passing internally within said enclosure in between said end-cap and said electrical module, wherein each module of the plurality of modules comprising side openings sufficient in size and shape to allow for a cable to pass internally within the enclosure and in-between said modules.

11. The apparatus of claim 7, wherein the one or more cables comprise a multi-wire cable comprising one or more power lines and one or more communication signal lines.

12. The apparatus of claim 1 further comprising two mounting brackets attached to said enclosure at the distal ends, wherein the two mounting brackets are mounting brackets that are configured to allow for mounting said apparatus horizontally within the computer rack while occupying one rack unit (1U) space of the computer rack, wherein said U-shaped plate has a length corresponding an internal width of slots within the computer rack.

13. The apparatus of claim 1 further comprising two mounting brackets attached to said enclosure at the distal ends, wherein the two mounting brackets are mounting brackets that are configured to allow for mounting said apparatus vertically to a computer rack without occupying a rack unit space of the computer rack.

14. The apparatus of claim 1 further comprises a din rail mounting element attached to the U-shaped back panel.

15. An apparatus having an enclosure, wherein said enclosure is mountable on a computer rack, said apparatus comprising:
a U-shaped plate forming a bottom face of said enclosure and at least a portion of a front face of said enclosure and at least a portion of a back face of said enclosure, wherein said U-shaped plate comprising a channel;
an electrical module comprising three faces, wherein said electrical module is configured to mate with said U-shaped plate via said channel, wherein, when said electrical module is mated with said U-shaped plate, the three faces of said electrical module form, at least partially, a top, the front and the back faces of the enclosure; and
two end-caps configured to be attached to said U-shaped plate at distal ends of said U-shaped plate, wherein, when said two end-caps are attached to said U-shaped plate, side walls of said two end-caps form two side faces of the enclosure;
wherein an end-cap selected from said two end-caps comprises two assemblies removably attached, said two assemblies comprising: (i) a removable assembly comprising an outer panel, a power inlet and a power supply circuit; and (ii) a housing assembly securely mating with said U-shaped plate; wherein said removable portion being removably attached to said housing portion; and
wherein said electrical module is a controller module, wherein said controller module is further comprised of two assemblies removably attached together comprising:
a removable assembly comprising a front panel and controller electronics; and
a second assembly housing securely mating with said U-shaped plate,
wherein said removable assembly being removably attached to said housing assembly.
